(19) United States
(12) Patent Application Publication
(10) Pub. No.: US 2025/0285519 A1
(43) Pub. Date: Sep. 11, 2025

(54) Wireless Communication System and Method for Vehicles

(71) Applicant: Tamir Rosenberg, Stevenson Ranch, CA (US)

(72) Inventor: Tamir Rosenberg, Stevenson Ranch, CA (US)

(21) Appl. No.: 19/033,448

(22) Filed: Jan. 21, 2025

Related U.S. Application Data
(60) Provisional application No. 63/563,397, filed on Mar. 10, 2024.

(51) Int. Cl. G08B 7/06; G08G 1/0967; H04W 4/40

(52) U.S. Cl. CPC G08B 7/06; G08G 1/096783; H04W 4/40

(57) ABSTRACT

This invention introduces a decentralized two-way communication system (DCS) for vehicles, operated by civilians and authorities, that complements existing Emergency Alert Systems (EAS) systems managed by governmental authorities, and the vehicle Vehicle-to-Everything (V2X) communications. The system allows vehicle drivers and occupants, pedestrians, authorities and other road users to transmit and receive messages and emergency alerts in between them, as well as to and from infrastructure. The DCS is linked to existing Vehicle Management Systems (VMS), and software applications for mobile devices. The DCS leverage the vehicle Vehicle-to-Everything (V2X) communication systems, and can be used in different communication embodiments such as: Vehicle-to-Vehicle (V2V); Vehicle-to-Infrastructure (V2I); Vehicle-to-Pedestrian (V2P); Vehicle-to-Cloud (V2C); and Vehicle-to-Network (V2N). An object of the DCS is to improve road safety, road awareness, sharing road conditions, weather updates, road hazard updates, emergency alert systems (EAS) and save lives.

### CROSS-REFERENCE TO RELATED APPLICATIONS

The present application includes subject matter disclosed in and claims priority to a provisional application entitled “Wireless Emergency Alert System and Method for Vehicles” having application No. 63/563,397 filed on Mar. 10, 2024.

### FIELD OF THE INVENTION

The present invention generally relates to EAS. More specifically, it relates to a decentralized two-way communication system operated by civilians and authorities that complements existing, EAS systems managed by authorities.

### BACKGROUND

Current EASs exhibit both strengths and weaknesses in their implementation. One of their primary strengths lies in their ability to rapidly disseminate critical information to a wide audience, leveraging various communication channels such as television, radio, and wireless devices. This widespread reach ensures that urgent messages, particularly those related to child abductions through Amber Alerts, can quickly reach the public, enhancing community engagement in response efforts. The implementation of emergency alert colors varies across different states in the United States, leading to a patchwork of systems with unique criteria and protocols. Each state often tailors its emergency alert system to address the specific needs and priorities of its population.

For instance, the Amber Alert system, designed to quickly notify the public about child abductions, may have variations in activation criteria, dissemination methods, and the level of detail provided in different states. Other colors represent other emergencies, for example: silver—missing adult or elderly person; blue—person fleeing who has injured a police officer; purple—missing person with disability; yellow—remain alert to weather forecast; orange—be prepared for weather; red—take action, shelter in place for weather; etc. Differences in alerts can be attributed to variations in state laws, law enforcement policies, and the perceived urgency and severity thresholds for activating these alerts. While this decentralized approach allows states to customize their systems based on local considerations, it also underscores the need for collaboration and standardization to ensure consistency and effectiveness in emergency alert communication nationwide. Efforts to harmonize alerting procedures can enhance public understanding, reduce confusion, and streamline response efforts, especially in cases that transcend state borders or impact a broader regional audience.

One notable weakness is the potential for false alarms or misuse, leading to public desensitization or skepticism. The high volume of non-critical alerts, sometimes unrelated to immediate threats, can dilute the system's effectiveness and compromise public trust. Moreover, the EAS faces challenges in adapting to evolving communication technologies, as some individuals may not receive alerts due to outdated devices or lack of access to modern communication platforms. One notable weakness of the EAS is the potential for false alarms, which can have significant consequences on public trust and response. The infamous false missile alert in Hawaii in 2018 serves as a stark example. The erroneous notification caused widespread panic and showcased the vulnerability of the system to human error. Such incidents not only risk desensitizing the public to alerts but can also lead to skepticism and complacency, with individuals dismissing future warnings as potential false alarms.

The EAS also faces challenges in adapting to evolving communication technologies. As younger generations increasingly rely on digital platforms, streaming services, and social media for information, there is a risk that they may not receive critical alerts through traditional channels. For instance, if an emergency alert is primarily broadcast through television and radio, it may not effectively reach individuals who have cut the cord on cable or abandoned traditional media consumption in favor of online alternatives. This digital divide poses a threat to the inclusivity and efficiency of the alert system. Moreover, the system's reliance on wireless emergency alerts (WEA) brings its own set of challenges. While WEA allows for targeted notifications to mobile devices, it may lack the granularity needed to provide detailed and context-specific information. This limitation can hinder the public's ability to make informed decisions during emergencies. For instance, a brief alert about an ongoing incident may not provide sufficient information for individuals to determine the severity of the situation or understand appropriate actions to take. The frequency of non-critical alerts is another concern. The EAS is utilized for various purposes, ranging from weather advisories to amber alerts, but the sheer volume of notifications can lead to alert fatigue. When individuals receive frequent, non-urgent alerts, they may become less responsive to critical messages, potentially diminishing the system's overall effectiveness. Furthermore, the lack of standardization and consistency in alert formats across different jurisdictions and platforms can create confusion.

The vehicle industry has taken steps to improve alert systems. U.S. Pat. No. 9,333,913B1 disclosed a real time vehicle safety alert system but it does not connect to any EAS systems. U.S. Pat. No. 6,229,438B1 disclosed a vehicular hazard warning system that interacts with a vehicle's internal controls but is not connected to external agency alerts. U.S. Pat. No. 10,189,352B2 disclosed a radio-based, intelligent safety system for vehicles but it is not a system connected to cellular communication towers. U.S. Pat. No. 9,290,145B2 disclosed a detection of a transport emergency event and directly enabling automatic notification of emergency notification to authorities but it does not include any community-wide alerts. European Patent No. EP2831858B1 disclosed a service of an emergency event based on proximity. However, it does not include an EAS. Canadian Patent No. CA3002563C disclosed an advanced warning system for road conditions ahead of a vehicle, however it does not include an EAS. U.S. Pat. No. 8,903,354B2 disclosed a method and system for emergency call arbitration but not for community alerts. U.S. Pat. No. 9,595,195B2 disclosed a wireless vehicle system for enhancing situational awareness for vehicles in proximity to one another, however it does not include any community-wide alerts. What is needed is a system that allows EASs to communicate directly with vehicles as well as mobile devices.

### SUMMARY OF THE INVENTION

The system herein disclosed and described provides a solution to the shortcomings in the prior art through the disclosure of a DCS. An object of the invention is to enhance the effectiveness of EASs to save lives and promote safety. The system leverages vehicle VMS and smart phone interactive capabilities to increase EAS effectiveness. By sharing real-time information, DCS networks can help prevent accidents and reduce their severity. DCS networks can optimize traffic flow by providing real-time information to drivers and occupants and traffic management systems. DCS optimizes traffic flow and reduces congestion, helping reduce fuel consumption and emissions. DCS networks are essential for the development of autonomous vehicles, as they provide the necessary information for vehicles to navigate safely and efficiently. The DCS can be used in other scenarios, including a pregnant woman driving to hospital and needs to notify vehicles in front of her and uses the DCS's V2X, to give her priority on the way. Drivers close to her will see on their console the notifications and understand why the vehicle behind is flashing lights and drive on the side of the road. In another scenario, a child left alone in a hot car and the vehicle itself sends a V2V alert to a nearby vehicle that just parked nearby and that can save the child before they are overcome by pediatric heatstroke. In yet another situation, the DCS can notify a vehicle driver or occupant who happens to be in the vicinity of a child who is the subject of an amber alert.

An objective of this DCS is to enhance the effectiveness of Emergency Alert Systems (EAS) by delivering targeted alerts. Current EAS implementations often broadcast indiscriminately to vast numbers of mobile devices, including those far from the hazard zone, leading to inefficiencies and “alert fatigue.” This invention ensures that only vehicles within a designated radius, determined by, but not limited to: GPS location, cell tower proximity and other vehicles in proximity and the like when receiving relevant notifications. For instance, in an Amber Alert on the city's south side, alerts are sent solely to vehicles connected to cell towers in that area. As an additional feature, cell phones within the same zone can also receive these alerts.

Another object of this DCS is to increase public engagement with EAS on roadways. In situations like Amber Alerts, where a suspect's vehicle is speeding, pedestrians may have limited visibility, but drivers and occupants are better positioned to spot such vehicles. By integrating alerts into VMS, drivers on the same road can receive real-time notifications.

Another object of the DCS is to provide V2V communication between vehicles, allowing them to share real-time information and exchange messages and alerts. These features can help prevent incidents and accidents by alerting drivers and vehicle occupants to potential hazards, missing persons, emergency situations ahead and the like.

Another object of the DCS is to provide V2N communication between vehicles and the broader internet, allowing them to access cloud-based services like real-time traffic updates, weather information, and emergency services. By sharing real-time information across V2X networks, the DCS can improve communications between drivers and agencies in a proactive effort to avoid hazardous situations, report hazardous conditions or events etc.

Another object of the DCS is to provide V2P communication between vehicle drivers, vehicle occupants, and pedestrians, especially in areas with hazardous conditions such as low visibility or blind spots, extreme weather, road rage, drunken drivers, criminal activity and the like. This enhanced messaging and communication tool can help prevent accidents involving drivers and pedestrians.

Another object of the DCS is to simplify public participation. Drivers and occupants spotting a vehicle matching an alert description can quickly report it by pressing a button on their VMS screen, which sends the vehicle's GPS location to authorities. Beyond emergency alerts, drivers and occupants can communicate directly with others in their vicinity, sending private or public messages, including warnings for severe weather, traffic hazards, or requests for assistance, such as flat tires or medical emergencies.

Another object of the DCS is to utilize autonomous technology. The system enhances EAS by facilitating autonomous communication between vehicles, pedestrians, and infrastructure. For example, a driver reporting a suspect vehicle can trigger V2V alerts, notifying nearby vehicles and enabling real-time collaboration. In critical situations, authorities could instruct vehicles to yield or modify traffic signals to assist in suspect apprehension. This level of interaction, while respecting constitutional rights, ensures heightened safety and cooperation.

Another object of the DCS system is to integrate rich media into EAS notifications via VMS displays, providing detailed information such as photos of abducted children or suspect vehicles. Real-time civilian-to-law enforcement communication allows updates, such as changes in suspect appearance, to improve alert accuracy. In natural disaster scenarios like tornado warnings, civilians can capture and relay images to other vehicles and officials, improving response efforts and potentially saving lives.

Another object of the DCS is to provide the ability to collect and transmit video evidence through integrated dash cameras. For instance, when a driver or occupant identifies a suspect vehicle, their dash cam can stream live video to authorities, confirming identities and bolstering evidence for legal proceedings.

Another object of the DCS system is to provide seamless integration with existing EAS platforms, ensuring compatibility while delivering advanced functionality to modernize public safety infrastructure.

It is briefly noted that upon reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the system on a driver's dashboard as part of the DCS.

FIG. 1A shows a perspective view of the system having law enforcement utilizing the DCS.

FIG. 2 shows a representative view of the system's V2V and V2X connections.

FIG. 3 shows the process operations of the DCS operations.

FIG. 4 shows the method of the system.

Other aspects of the present invention shall be more readily understood when considered in conjunction with the accompanying drawings, and the following detailed description, neither of which should be considered limiting.

### DETAILED DESCRIPTION OF FIGURES

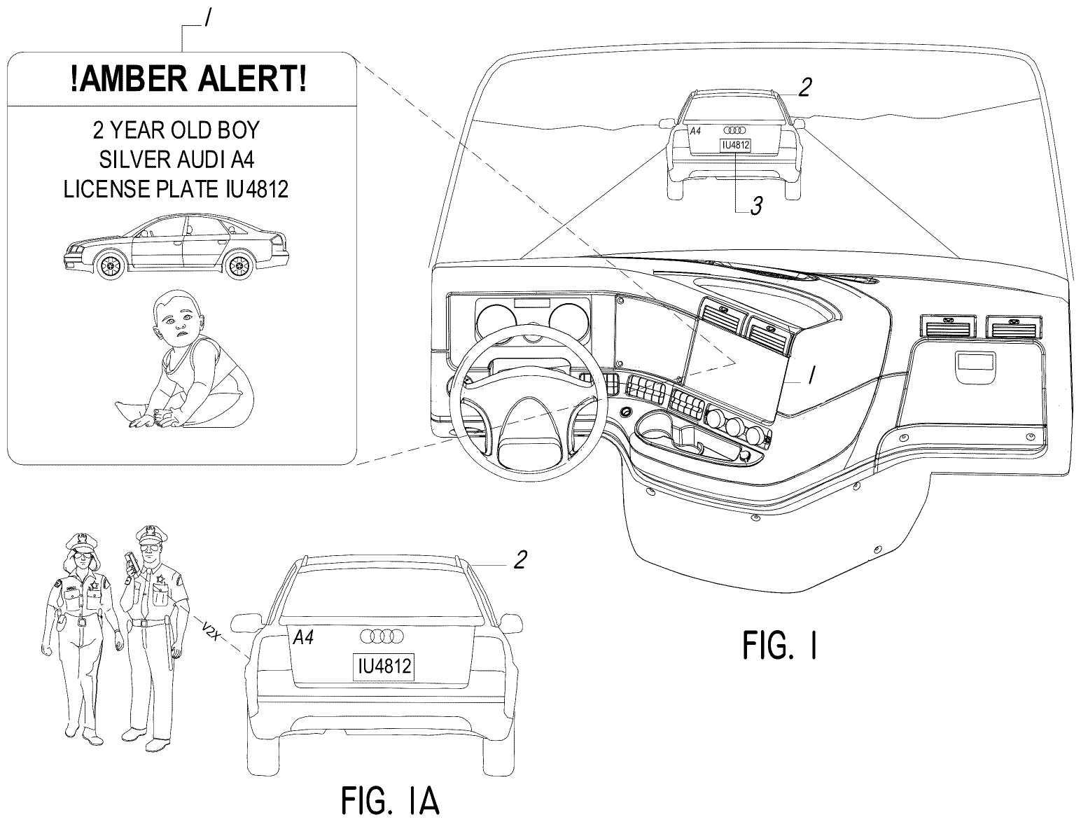

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure. The DCS illustrated in FIG. 1 represents a sophisticated solution for disseminating emergency management system (EMS) alerts to users via in-vehicle smart screens, labeled as 1. This system provides a highly detailed and interactive method of delivering critical information about a perpetrator's vehicle, labeled as 2, and other emergency scenarios. These alerts are tailored to specific incidents, such as an Amber alerts to help find a child who has been abducted and is in imminent danger, Silver Alerts for missing adults or elderly individuals, Blue Alerts for suspects fleeing after injuring law enforcement officers, Purple Alerts for missing individuals with disabilities, Ebony Alerts for missing African Americans, and Feather Alerts for unexplained disappearances of indigenous individuals or women. Weather-related alerts include Yellow for forecast awareness, Orange for preparedness, and Red for immediate action, such as shelter-in-place orders. These alerts are comprehensive, featuring not only textual descriptions but also multimedia elements like high-resolution digital images, video clips, and detailed descriptions, including identifiers such as the vehicle description and license plate number, labeled as 3.

The DCS leverages a V2X network and improves communications between vehicle drivers, vehicle occupants and agencies in a proactive effort to avoid hazardous situations, report hazardous conditions or events etc. These technologies ensure a robust and redundant communication framework that maintains functionality even in challenging environments. The in-vehicle smart screen hardware includes high-definition touch displays with embedded haptic feedback for an intuitive user interface that can be integrated into a vehicle's VMS and include biometric authentication (e.g., fingerprint or facial recognition) for secure access, and advanced voice-recognition software powered by natural language processing (NLP) algorithms, allowing drivers and occupants to interact with the system hands-free. The smart screen also incorporates an adaptive brightness sensor for improved visibility under varying lighting conditions and edge-to-edge OLED or AMOLED displays for crisp visuals. Drivers and occupants can send messages to one another, a group of vehicles with predefined or user defined messages. Said messages can be sent or received on expended networks like cellular frequencies or satellite stations, etc. Messages can also be sent by authorities and federal and local agencies such as but not limited to: Police, FEMA, IPAWS, EAS, and the like. When these EAS messages are sent, drivers and occupants can reply to messages and even provide information on the alert and acknowledge or add information to the alert.

In addition to communication technologies, the system integrates a modular hardware platform that supports compatibility with diverse Vehicle Management Systems (VMS) across different manufacturers. This includes embedded telematics units (ECUs) equipped with AI-driven processors, such as edge AI chips, that enable real-time analytics directly within the vehicle. These processors utilize machine learning models to filter and prioritize incoming alerts based on the driver's and occupant's context, such as location, route, and current traffic conditions. The cloud network connected to this system employs advanced data encryption protocols like quantum-resistant cryptography to ensure the security of transmitted information.

FIG. 1A demonstrates how this system integrates with law enforcement software and hardware. For example, police vehicles that are equipped and connected to the DCS' V2X network and augmented reality (AR) dashboards can overlay alert details onto their windshields, allowing officers to focus on their surroundings while staying informed. The system also integrates with license plate recognition (LPR) cameras and automated number plate recognition (ANPR) systems installed in patrol vehicles and fixed locations to identify and track perpetrator vehicles automatically.

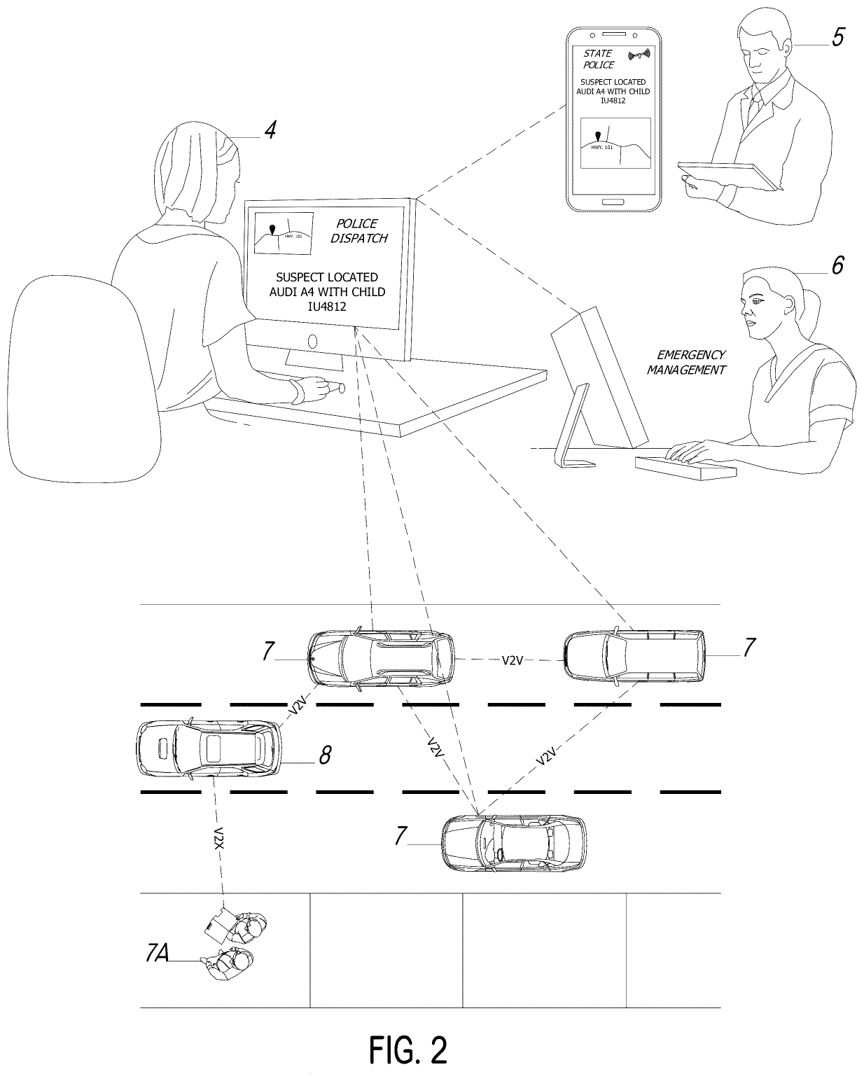

FIG. 2 expands on the DCS's ability to facilitate Vehicle-to-Vehicle (V2V) and Vehicle-to-Everything (V2X) communication. Vehicles labeled as 7 exchange real-time data between them and with a perpetrator's vehicle, labeled as 8, using secure communication protocols. V2V communication transmits essential data such as vehicle type, speed, GPS location, and trajectory, while V2X communication includes exchanges with roadside infrastructure, pedestrians (labeled as 7A), and connected devices like smartphones. Pedestrian interaction is enabled through smart wearables such as fitness trackers and AR glasses equipped with low-power communication modules that receive alerts and share location data with the system. Communications can also occur between vehicle drivers, and other vehicle's occupants.

The DCS incorporates a sophisticated sensor array within vehicles, including LIDAR, radar, and camera systems, which continuously monitor the environment and enhance the detection and tracking of perpetrator vehicles. These sensors work alongside high-performance onboard GPUs to process large volumes of data in real time. The system's software employs federated learning to continuously update and improve its machine learning models without directly transferring sensitive data to the cloud, preserving user privacy. These learning models can operate locally within vehicle VMSs or remotely on cloud networks.

Drivers and occupants receiving alerts can manually or automatically transmit real-time information to law enforcement through the in-vehicle interface. For example, a driver or occupant could capture live video from their vehicle's dashboard camera and upload it securely to the cloud network for immediate access by dispatch agencies. Law enforcement dispatch centers, labeled as 4, including police (5), firefighters, Homeland Security, emergency management agencies (6), and weather agencies, can aggregate and analyze this data using AI-powered situational awareness software to identify patterns, predict suspect behavior, and optimize response strategies.

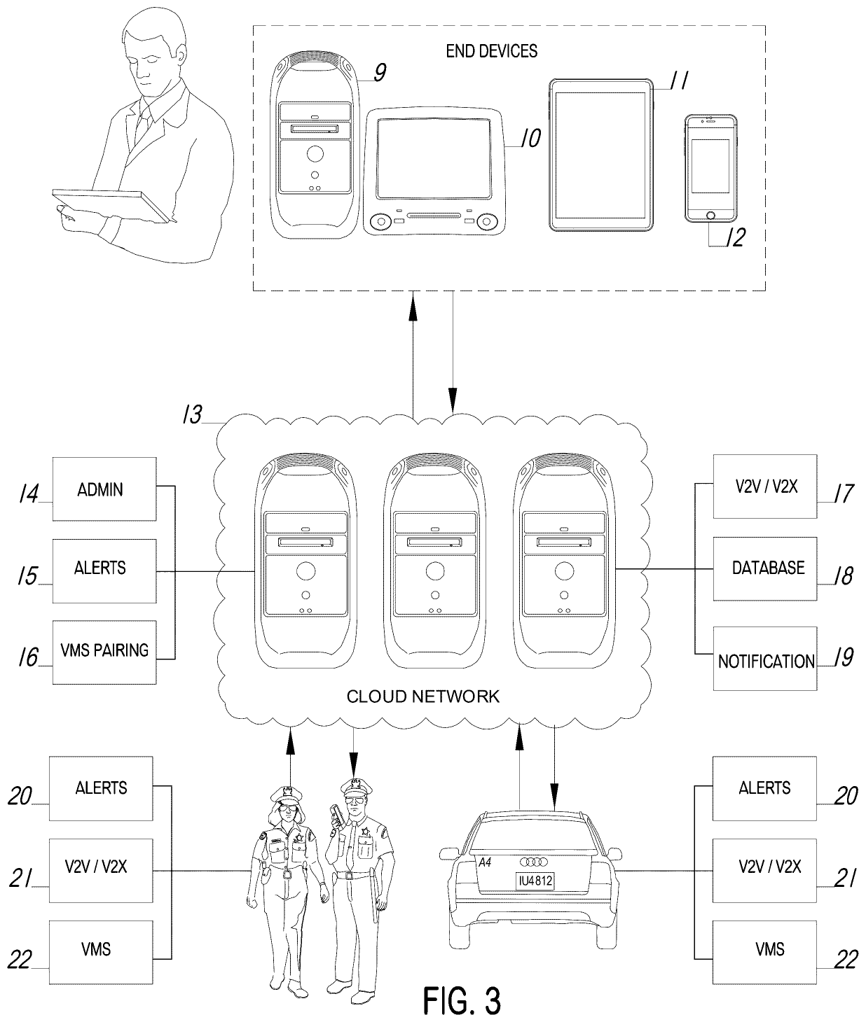

FIG. 3 illustrates the system's cloud network, labeled as 13, and its comprehensive operational framework. The cloud infrastructure supports distributed edge computing, enabling real-time data processing at multiple nodes for faster response times. Administrative functions, labeled as 14, handle subscription management, user authentication, and payment processing through secure blockchain-based systems to enhance transparency and accountability. Alert management, labeled as 15, uses an AI-driven decision engine to dynamically prioritize and customize alerts based on local and federal regulations, as well as user preferences. Data transmitted by drivers and occupants can also be stored on a cloud network or internally on the vehicle's VMS.

The DCS's VMS pairing functionality, labeled as 16, supports over-the-air (OTA) updates to ensure ongoing compatibility with evolving vehicle technologies. V2V and V2X configuration, labeled as 17, allows for customizable bandwidth allocation, data prioritization, and communication permissions, ensuring seamless integration across a wide range of vehicles and devices. The historical database, labeled as 18, is backed by a hybrid blockchain and relational database architecture, offering both immutability for audit trails and fast query processing for operational efficiency. Active notification settings, labeled as 19, give users granular control over the content, broadcast mediums, and authorization levels for received alerts, ensuring tailored and relevant notifications.

The DCS connects with authorized devices, including smartphones, tablets, laptops, and desktops, labeled respectively as 12, 11, 10, and 9. To enhance accessibility, the system supports cross-platform applications with multi-factor authentication (MFA) and biometric login options. The integration of advanced digital assistants powered by generative AI enhances user interaction, providing contextual explanations and recommendations based on the alert content. By leveraging these cutting-edge hardware and software solutions, the system ensures comprehensive coverage, rapid dissemination of critical information, and enhanced coordination between authorities, drivers, occupants, pedestrians, and emergency responders, thereby significantly improving public safety and response efficiency. FIG. 3 also showing the vehicle as well as driver office and occupant office (in this example police) receiving and transmitting: alerts 20 (can include but not limited to Amber alerts, Wireless Emergency Alerts (WEAs), Emergency Alert System (EAS) alerts, weather alerts, and the like); V2V and V2 messages 21 and interacting with the VMS 22.

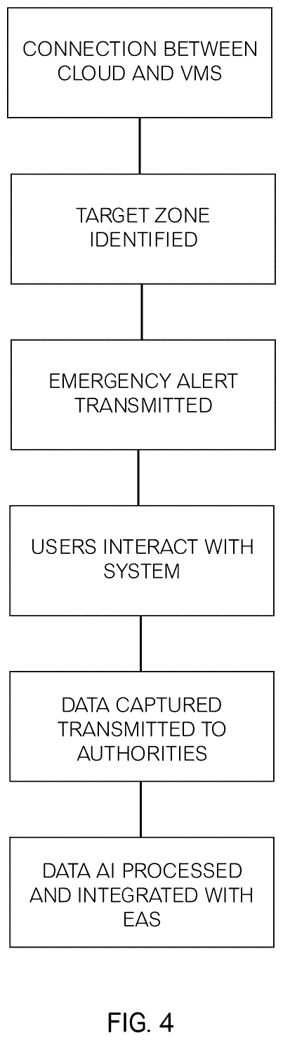

FIG. 4 shows the method of the system. The method for delivering targeted emergency alerts to and from vehicle drivers and occupants using a wireless emergency alert system for vehicles includes the following steps. First, the wireless emergency alert system for vehicles is provided. A connection is then established between a cloud-based network and a Vehicle Management System (VMS) within vehicles. Next, a geographic target zone is identified based on proximity to a specified location or cell towers. Emergency alerts along a single and multiple channels are transmitted to vehicles within the geographic target zone via Vehicle-to-Everything (V2X) communication (V2X communications can use different channels, different frequencies and different protocols). Vehicle drivers and occupants are enabled to interact with alerts through VMS-integrated touch displays messages (original and replies), voice recognition systems, or mobile applications anonymously or their identity can be revealed to receivers. Messages and alerts may be of different types. For example, messages and alerts can identify the sender or be sent anonymously. Messages and alerts can be sent privately, as broadcast, or public message, sent to some or all vehicles and pedestrians. Real-time environmental data, including video streams from dash cameras, is captured and transmitted to authorities. Said data can include but is not limited to image, audio, video, a video stream, location, and vehicle sensor data. This data is processed through onboard AI-driven processors to prioritize and filter alerts based on alert type, location, context, and traffic conditions. All of the aforementioned activities such as messages, alerts, audio, imagery, etc. are recorded and stored on at least one of a cloud service and in the vehicle management system. Activities can also include operations that the DCS itself, or the vehicle driver or vehicle occupants are doing using the system and represents a log of operations. Finally, seamless integration with existing Emergency Alert Systems is provided to ensure compatibility and extended functionality.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A decentralized two-way communication system for vehicles comprising:
a) a software program configured to facilitate communication between vehicle drivers, vehicle occupants, pedestrians and infrastructure;
b) wherein the software program is using the vehicle's Vehicle-to-Everything (V2X) hardware and software communication system to communicate between vehicles, pedestrians and infrastructure;
c) a software module to communicate with the Vehicle Management System (VMS) within vehicles; and
d) a driver and occupants user interface (UI) that can be integrated in the VMS.

2. A method for delivering messages and alerts for vehicles, the method includes a non-transitory computer-readable medium storing instructions that, when executed by a processor, causes the following steps to be performed:
a) providing the decentralized two-way communication system of claim 1;
b) monitoring the V2X network for incoming messages and alerts, and when a message and alerts arriving, checking if the vehicle is the target based on at least one of the message and alert type, distance, location, area or amount of relays and if so, displaying the message and alert on the driver UI;
c) optionally monitoring at least one of other networks such as Bluetooth, WiFi, Cellular or Satellite for incoming messages and alerts, and when a message and alert arriving, checking if the vehicle is the target based on at least one of the message and alert type, distance, location, area or amount of relays and if so, displaying the message and alert on the driver UI;
d) optionally allowing a driver or occupant to reply to a message and alert;
e) optionally allowing a driver or occupant to send a new message and alert; and
f) optionally processing data through onboard processors for prioritizing and filtering messages and alerts based on location, context, and traffic conditions.

3. The method of claim 2, wherein monitoring a single channel or a multiple channels.

4. The method of claim 2, where the messages can be public or private.

5. The method of claim 2, where the messages can be identified or anonymous.

6. The method of claim 2, wherein the messages and alerts can include the sender details such as but not limited to the vehicle make, model, color, license plate, vehicle identification number and location.

7. The method of claim 2, wherein the messages and alerts sources are from authorities such as but not limited to Federal Emergency Management Agency (FEMA), Integrated Public Alert and Warning System (IPAWS), Police, and the like, and the messages and alerts types can include but not limited to Amber alerts, Wireless Emergency Alerts (WEAs), Emergency Alert System (EAS) alerts, weather alerts, and the like.

8. The method of claim 2, wherein the vehicle driver and vehicle occupants interacting with messages and alerts through the VMS-integrated touch displays, voice recognition systems, and mobile applications.

9. The method of claim 2, wherein the vehicle driver and vehicle occupants creating messages and alerts manually or use predefined messages and alerts.

10. The method of claim 2, wherein each vehicle acting as a relay and forward the received messages and alerts to other vehicles, pedestrians and infrastructure by means of at least one of the V2X network as well as other networks such as Bluetooth, WiFi, Cellular and Satellite.

11. The method of claim 10, further comprising that the relaying of a message and alert can be limited by at least one of a message and alert type, distance, location, area or amount of relays.

12. The method of claim 2, wherein each of the messages, alerts and activities being recorded and stored on at least one of a cloud service and in the vehicle management system.

13. The method of claim 2, wherein the vehicle's Vehicle Management System (VMS) sending or replying to messages and alerts automatically based on logic and rules from the vehicle's Vehicle Management System (VMS) or other vehicle's systems.

14. The method of claim 2, wherein a message and alert can include but not limited to text, image, audio, video, a video stream, location, and vehicle sensor data.

15. The method of claim 2, wherein messages and alerts being sent to other vehicles, pedestrians and infrastructure over expanded networks like Bluetooth, WiFi, Cellular and Satellite networks.

16. The decentralized two-way communication system for vehicles of claim 1, wherein the decentralized two-way communication system employing encryption.
